(19) United States
(12) Patent Application Publication
(10) Pub. No.: US 2018/0192810 A1
(43) Pub. Date: Jul. 12, 2018

(54) TEA STRAINER

(71) Applicant: Anthony V. Codispoti, Columbus, OH (US)

(72) Inventor: Anthony V. Codispoti, Columbus, OH (US)

(21) Appl. No.: 15/400,596

(22) Filed: Jan. 6, 2017

(51) Int. Cl. A47J 31/06

(52) U.S. Cl. CPC A47J 31/06

(57) ABSTRACT

A strainer, into which a product may be placed, permits extraction of substances from the product with a liquid without disbursing the product into the liquid. The strainer can be used with various products, such as herbs, tea, spices and the like. The strainer includes a compression member formed at one end of a shaft that is movable inside a basket portion. The basket portion may be covered with a lid that includes a hole therein through with the shaft moves. The shaft permits the user to move the basket portion within the liquid while, due to its length and rigidity, not getting lost in the liquid and not requiring the user to get too close to the liquid. The compression member can squeeze liquid out of the product within the basket portion when the user wishes to remove the product from the liquid.

### BACKGROUND OF THE INVENTION

### 1. Field of the Invention

One or more embodiments of the invention relates generally to beverage accessories. More particularly, the invention relates to a tea strainer that can compress and remove liquid from tea leaves, spices, herbs, and the like.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Containers for infusion of tea, spices and other condiment particles are immersed into liquid such as hot water, oils and beverages, and generally utilize an enclosed screen or perforated container to eliminate the need to strain the solid particles from the liquid after infusion. Solid particles, such as tea leaves, are contained within the infuser vessel and are exposed to the liquid by passage of liquid through the screen or perforation of the vessel. In the case of tea and other infusions, manufactured tea bags or use of cheese cloth to wrap spices in a package perform the same function in a disposable format.

A disadvantage of conventional manufactured tea bags is that the user has no control over the amount of tea used and therefore the strength of tea produced depends on the user regulating the time of infusion or requires the user to agitate the tea bag with a spoon or suspending string. As well, use of premanufactured tea bags prevents the user from utilizing their own selected mix or from creating different mixes of tea flavors to suit their own tastes.

To provide a more permanent reusable system, an openable vessel is often used which is immersed in liquid hanging from a chain or string. A disadvantage of such reusable, and disposable infusers, including tea bags, is that the user often drops the chain or string into the hot liquid and must fish it out from the hot liquid creating an inconvenience and safety hazard.

A further disadvantage is the slow speed with which materials contained within an infuser or strainer actually perform the infusion process. To speed up the process, users often raise and lower a tea bag or infuser within the liquid to stir the solid particles and increase flow of liquid past the tea leaves, thereby increasing the speed of infusion. Because the liquid is often hot, splashing of the liquid is dangerous, the heat and steam escapes from the liquid, and the conventional method of raising or lowering an infuser or tea bag to speed up the process is highly undignified and unsatisfactory.

In view of the foregoing, there is a need for an improved tea strainer that overcomes problems encountered with conventional tea strainers

### SUMMARY OF THE INVENTION

Embodiments of the present invention provide a strainer for extracting a substance from a product comprising a basket portion having a side member, a base member and an open top; a plurality of holes through at least one of the side member and the base member; a cover portion removably attached to the basket portion, covering the open top; a shaft fitting through an opening in the cover portion; a compression member on one end of the shaft, the compression member disposed within an interior of the strainer when the cover portion is attached to the basket portion, wherein the compression member is movable between a retracted position, where the compression member is adjacent the cover portion, and a compressing position, where the compression is moved toward the base member of the basket portion, compressing the product therein.

Embodiments of the present invention further provide a strainer for extracting a substance from a product comprising a basket portion having a side member, a base member and an open top; a plurality of holes through at least one of the side member and the base member; a cover portion removably attached to the basket portion, covering the open top; a shaft fitting through an opening in the cover portion; a compression spring disposed about the shaft between the shaft handle and an exterior part of the cover portion, the compression spring resiliently urging the compression member in a retracted position; a compression member on one end of the shaft, the compression member disposed within an interior of the strainer when the cover portion is attached to the basket portion, wherein the compression member is movable between the retracted position, where the compression member is adjacent the cover portion, and a compressing position, where the compression is moved toward the base member of the basket portion, compression the product therein.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a side view of a tea strainer according to an exemplary embodiment of the present invention;

FIG. 2 is a perspective view of the tea strainer of FIG. 1;

FIG. 3 is an exploded perspective view of the tea strainer of FIG. 1, showing each of the parts separately;

FIG. 4 is a partially exploded perspective view of the tea strainer actuation trigger attached to the strainer cover, with the spring cover and support knob separated therefrom;

FIG. 5A is a bottom perspective view of a strainer cover of the tea strainer of FIG. 1;

FIG. 5B is a top perspective view of the strainer basket of the tea strainer of FIG. 1;

FIG. 6 is a cross-sectional view of the tea strainer of FIG. 1;

FIG. 7 is a side view of a basket cover and sliding compression member of a tea strainer according to an exemplary embodiment of the present invention;

FIG. 8 is a side view of a strainer basket usable with the basket cover and sliding compression member of FIG. 7; and

FIG. 9 is a side view of a sliding compression member usable with the strainer basket of FIG. 8.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a strainer into which a product may be placed to permit extraction of substances from the product with a liquid without disbursing the product into the liquid. The strainer can be used with various products, such as herbs, tea, spices and the like. The strainer includes a compression member formed at one end of a shaft that is movable inside a basket portion. The basket portion may be covered with a lid that includes a hole therein through with the shaft moves. The shaft permits the user to move the basket portion within the liquid while, due to its length and rigidity, not getting lost in the liquid and not requiring the user to get too close to the liquid. The compression member can squeeze liquid out of the product within the basket portion when the user wishes to remove the product from the liquid.

As used herein, the term “strainer” may be used interchangeably with other terms of art, such as an infuser, for example.

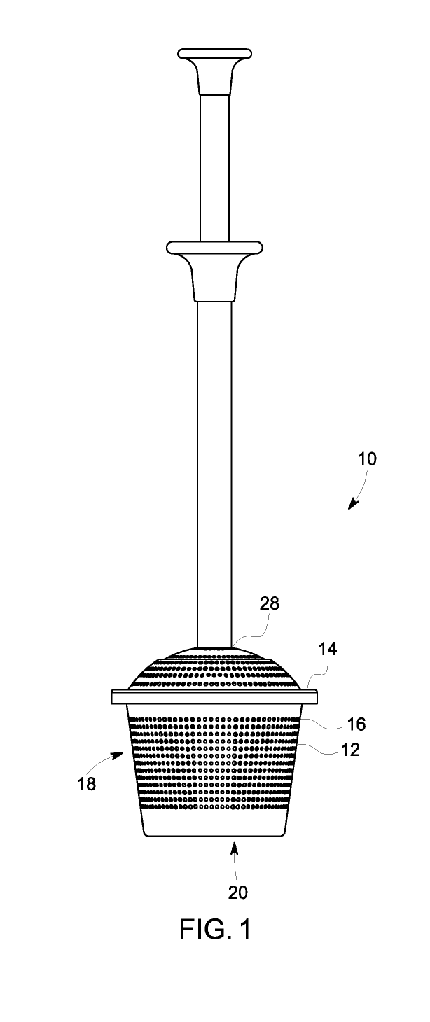

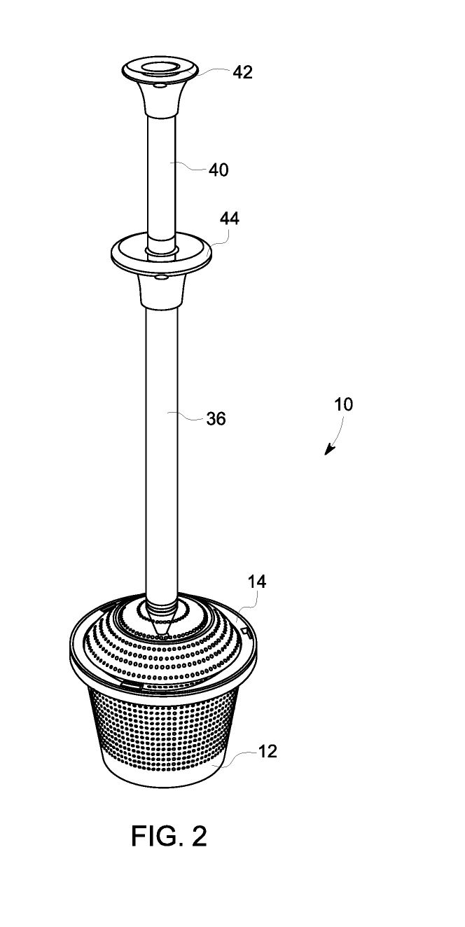

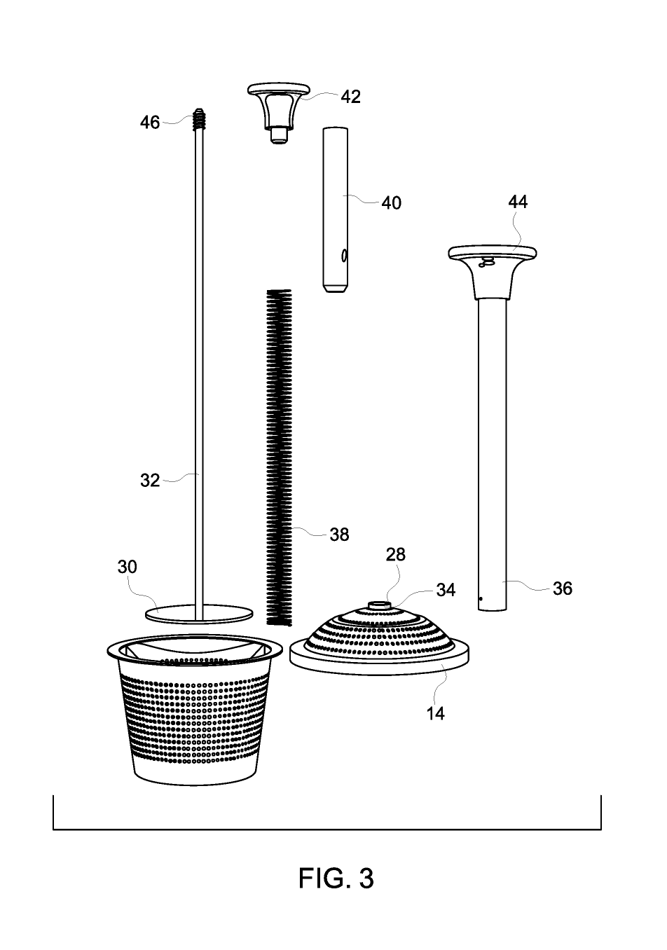

Referring now to FIGS. 1 through 6, a strainer 10, also referred to as a tea strainer 10, infuser 10, or tea infuser 10, for example, can include a basket portion 12 and a cover portion 14 fitting onto an open end of the basket portion 12. The basket portion 12 can include a plurality of perforations 16 disposed on at least one of the side member 18 or the bottom member 20 thereof. The perforations 16 may be sized to permit liquid to flow therethrough but to retain a substance, such as herbs, spices, tea leaves, or the like, inside the basket portion 12.

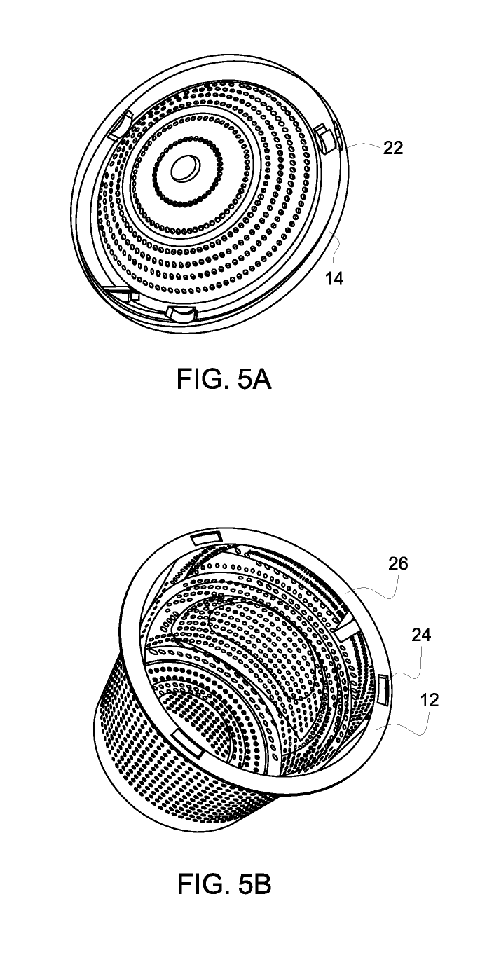

As detailed in FIGS. 5A and 5B, the cover portion 14 can engage with the basket portion 12. Various engagement mechanisms may be used to affect this removable closure. For example, as shown in FIGS. 5A and 5B, the cover portion 14 can include protruding tabs 22 that can twist lock into holes 24 in a rim 26 of the basket portion 12.

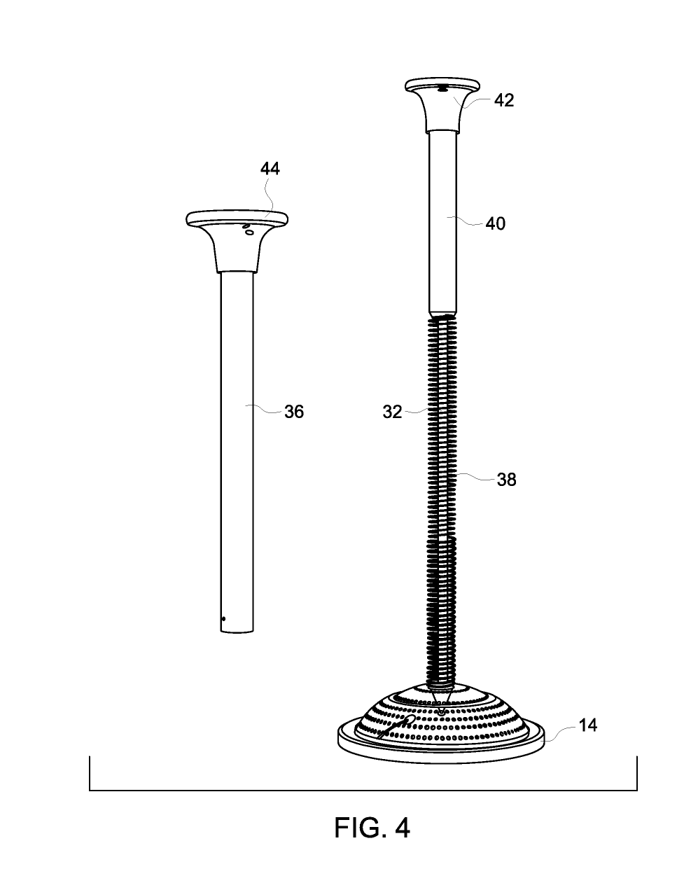

The cover portion 14 can include a hole 28 in a central portion thereof. The hole 28 can permit a shaft 32 of a compression member 30 to pass therethrough. A compression spring 38 may fit about the shaft 32 of the compression member 30 and sleeve 40 may fit about the shaft 32 above the spring 38, as shown in FIG. 4. Handle 42 may attach to an end 46 of the shaft 32 by various means, such as via threads, for example. In this configuration, the compression spring 38 may be disposed between a top of the cover portion 14 and the sleeve 40.

A fixed tubular member 36 may attach to the top 34 of the cover portion 14 and may receive the spring 38 therewithin. The fixed tubular member 36 can also receive a portion of the sleeve 40 and the remainder of the sleeve 40 and the handle 42 extend from a distal end of the fixed tubular member 36.

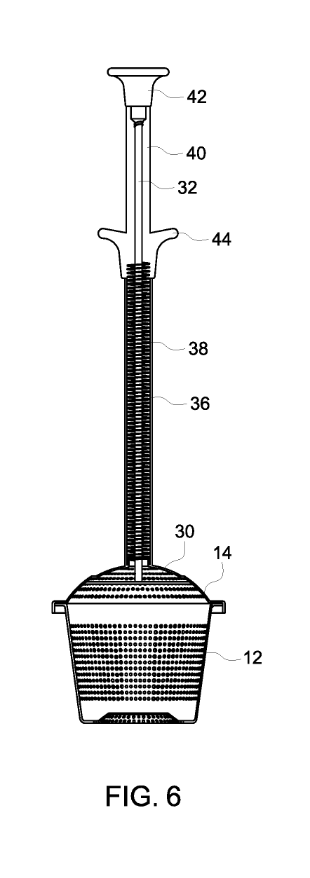

In this configuration, best viewed in cross-sectional view of FIG. 6, the compression spring 38 resiliently urges the compression member 30 at a top portion of the inside of the cover portion 14. The user can depress the handle 42 toward the basket portion 12 to resiliently urge the compression member 30 into the basket portion 12, compression any elements, such as tea leaves, for example, within the basket portion 12. A fixed handle 44, disposed about the end of the fixed tubular member 36 can provide a user an easy mechanism to permit squeezing the handle 42 toward the fixed handle 44 with one hand to affect movement of the compression member 30 into the basket portion 12.

The tea strainer 10 of the present invention solves many issues with conventional practices. For example, the string of a tea bag, which may get mixed into the hot liquid when making conventional tea, is not present and the extended shaft 32 of the compression member 30 is rigid and extends well out of the container of hot liquid. Similarly, when moving the basket portion 12 in the hot liquid, a user can be well separated from the liquid, thereby preventing possible burns from hot liquid and/or steam.

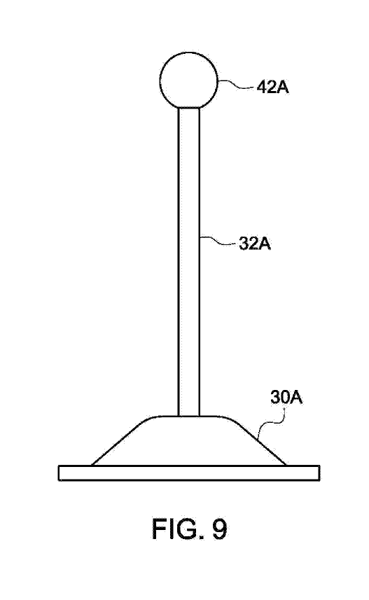

While a round basket portion 12 is shown, other shapes are contemplated for the basket portion 12 within the scope of the present invention. When differently shaped basket portions 12 are used, the cover portions 14 and the compression member 30 may each be suitably shaped similar to the basket portion 12. In some embodiments, the side members 18 of the basket portion 12 may be angled with respect to the base portion 20, as shown in FIG. 1, for example. In other embodiments, the side portions may be orthogonal to the base portion, such as shown with the basket portion 12A of FIG. 8.

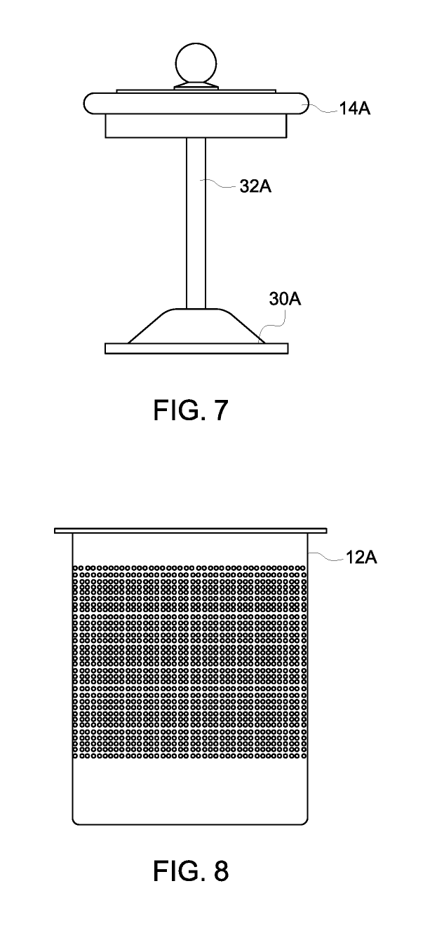

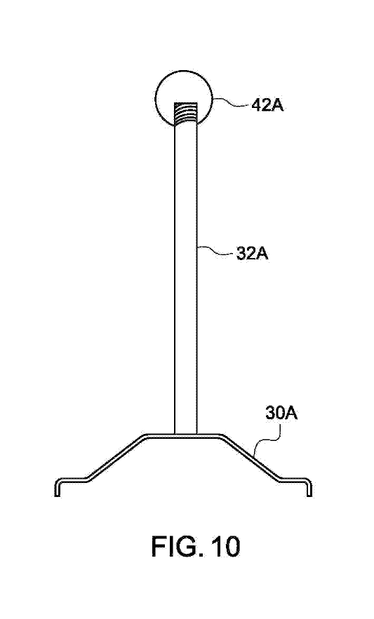

Referring now to FIGS. 7 through 10, in some embodiments, the spring mechanism described above, which keeps the compression member 30 adjacent the cover portion 14, as discussed above, may be optional, where a compression member 30A is attached to a shaft 32A with a handle 42A disposed opposite the compression member 30A. The shaft 32A may pass through a lid portion 14A. When the lid portion 14A is attached to the basket portion 12A, the compression member 30 may move inside basket portion 12A to compress items, such as tea leaves, or the like, therein. The embodiment of FIGS. 7 through 10 may function similarly to that of FIGS. 1 through 6, with the exception of the spring member to maintain the compression member in a retracted configuration.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A strainer for extracting a substance from a product comprising:
a basket portion having a side member, a base member and an open top;
a plurality of holes through at least one of the side member and the base member;
a cover portion removably attached to the basket portion, covering the open top;
a shaft fitting through an opening in the cover portion;
a compression member on one end of the shaft, the compression member disposed within an interior of the strainer when the cover portion is attached to the basket portion, wherein
the compression member is movable between a retracted position, where the compression member is adjacent the cover portion, and a compressing position, where the compression is moved toward the base member of the basket portion, compressing the product therein.

2. The strainer of claim 1, further comprising a shaft handle at an end of the shaft opposite the compression member.

3. The strainer of claim 1, wherein the side member and the base member each include a plurality of holes, wherein the plurality of holes is sized to permit liquid therethrough, but to prevent the escape of the products from the interior of the strainer.

4. The strainer of claim 1, further comprising a plurality of cover holes formed in the cover portion.

5. The strainer of claim 2, further comprising a compression spring disposed about the shaft between the shaft handle and an exterior part of the cover portion, the compression spring resiliently urging the compression member in the retracted position.

6. The strainer of claim 5, further comprising a fixed tubular member disposed about the spring.

7. The strainer of claim 6, further comprising a tubular member handle disposed at an end of the fixed tubular member.

8. The strainer of claim 5, further comprising a sleeve disposed between the shaft handle and the spring.

9. The strainer of claim 5, wherein the shaft handle is removable from the shaft.

10. A strainer for extracting a substance from a product comprising:
a basket portion having a side member, a base member and an open top;
a plurality of holes through at least one of the side member and the base member;
a cover portion removably attached to the basket portion, covering the open top;
a shaft fitting through an opening in the cover portion;
a compression spring disposed about the shaft between the shaft handle and an exterior part of the cover portion, the compression spring resiliently urging the compression member in a retracted position;
a compression member on one end of the shaft, the compression member disposed within an interior of the strainer when the cover portion is attached to the basket portion, wherein
the compression member is movable between the retracted position, where the compression member is adjacent the cover portion, and a compressing position, where the compression is moved toward the base member of the basket portion, compression the product therein.

11. The strainer of claim 10, further comprising a shaft handle at an end of the shaft opposite the compression member.

12. The strainer of claim 10, wherein the side member and the base member each include a plurality of holes, wherein the plurality of holes is sized to permit liquid therethrough, but to prevent the escape of the products from the interior of the strainer.

13. The strainer of claim 10, further comprising a plurality of cover holes formed in the cover portion.

14. The strainer of claim 11, further comprising a fixed tubular member disposed about the spring.

15. The strainer of claim 14, further comprising a tubular member handle disposed at an end of the fixed tubular member.

16. The strainer of claim 15, further comprising a sleeve disposed between the shaft handle and the spring.

17. The strainer of claim 16, wherein the sleeve is movable inside the fixed tubular member through an opening in the tubular member handle when the compression member is moved into the compressing position.

18. The strainer of claim 15, wherein the tubular member handle and the shaft handle are disposed to be squeezed toward each other by a single hand of a user.

19. The strainer of claim 11, wherein the shaft handle is removable from the shaft.
